(19) United States
(12) Patent Application Publication
(10) Pub. No.: US 2026/0361665 A1
(43) Pub. Date: Nov. 12, 2026

(54) ARBITRATION USING SHARED CREDITS AND DEDICATED CREDITS

(71) Applicant: NVIDIA Corporation, Santa Clara, CA (US)

(72) Inventors: Naveen Kumar Narrishetti, Warangal (IN); Sathyanarayan Balaji, Bangalore (IN); Kiran Kumar Muralidharan, Bengaluru (IL)

(21) Appl. No.: 19/205,253

(22) Filed: May 12, 2025

(51) Int. Cl. H04L 49/253

(52) U.S. Cl. CPC H04L 49/254

(57) ABSTRACT

Technologies for arbitrating packets using shared credits and dedicated credits are described. One interconnect circuit includes a physical (PHY) layer comprising a transmitter, and a data link layer coupled to the PHY layer. The data link layer includes credit-check logic coupled between first-level arbitration logic and second-level arbitration logic. The credit-check logic receives, from the first-level arbitration logic for each of a plurality of traffic types, a selected request to send a packet over a link. The credit-check logic blocks block one or more of the selected requests from being passed from the first-level arbitration logic to the second-level arbitration logic responsive to determining i) a lack of available shared credits in a shared credit pool, or ii) a lack of available dedicated credits assigned to the respective traffic type.

### TECHNICAL FIELD

At least one embodiment pertains to processing resources used to arbitrate packets using shared credits and dedicated credits. For example, at least one embodiment pertains to an interconnect circuit with a physical (PHY) layer and a data link layer with credit-check logic to block selected packets from selection responsive to a lack of available shared credits in a shared credit pool above a specified minimum amount of shared credits or a lack of available dedicated credits assigned to a traffic type.

### BACKGROUND

Arbitration in communications and networking refers to the process of managing access to a shared communication medium or resource. It ensures that multiple devices, nodes, or processes can transmit or receive data without conflicts, congestion, or unfair allocation. An arbiter is an entity that resolves disputes, makes decisions, or controls access to the shared resource(s). In the context of arbitration, starvation can occur when a lower-priority request or process is indefinitely delayed or denied access to resources due to continuous preference given to higher-priority requests. For example, if a system always prioritizes high-priority requests without fairness mechanisms, lower-priority requests may never get serviced.

### BRIEF DESCRIPTION OF DRAWINGS

Various embodiments in accordance with the present disclosure will be described with reference to the drawings, in which:

FIG. 1 is a block diagram of a communication system having an interconnect circuit with an arbiter with credit-check logic that uses a specified minimum amount of shared credits according to at least one embodiment.

FIG. 2 is a block diagram of an interconnect circuit with a physical layer (PHY layer) and a data link layer with credit-check logic according to at least one embodiment.

FIG. 3A is a block diagram of basic credit-based throttling logic with dedicated credits per client according to one implementation.

FIG. 3B is a block diagram of credit-based throttling logic with a mixed pool of shared pool credits and dedicated pool credits across clients according to one implementation.

FIG. 3C is a table illustrating a starvation scenario caused by the credit-based throttling logic of FIG. 3B according to one implementation.

FIG. 4 is a block diagram of credit-based throttling logic with a mixed pool of shared pool credits with a specified minimum amount of shared credits and dedicated pool credits for multiple client groups according to at least one embodiment.

FIG. 5 is a block diagram of credit-based throttling logic with credit replenishment logic for the mixed pool of shared pool credits with the specified minimum amount of shared credits and dedicated pool credits for multiple client groups according to at least one embodiment.

FIG. 6 is a flow diagram of an example method arbitrating packet requests using a specified minimum amount of shared credits according to at least one embodiment.

FIG. 7A illustrates an example communication system with an arbiter with credit-check logic, in accordance with at least some embodiments.

FIG. 7B illustrates a block diagram of an example communication system employing a transmitter with arbiter with credit-check logic, according to at least one embodiment.

FIG. 8 illustrates an example computer system including a spectrum hardware engine and an error correction block according to at least one embodiment.

FIG. 9 is a block diagram of a computing system having two processing devices coupled to each other and multiple networks according to at least one embodiment.

FIG. 10 is a block diagram of a computing system having a central processing unit (CPU) and a graphics processing unit (GPU) in a single integrated circuit according to at least one embodiment.

FIG. 11 is a block diagram of a computing system having tensor core graphics processing units (GPUs) according to at least one embodiment.

### DETAILED DESCRIPTION

Technologies for arbitrating packets using shared credits and dedicated credits are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

As described above, there can be scenarios where arbitration in networking and communications can lead to starvation. As described above, starvation can occur when a lower-priority request or process is indefinitely delayed or denied access to resources due to continuous preference given to higher-priority requests. One conventional arbitration scheme relies on two-level arbitration, where a first level (“level-1”) involves arbitration among requests of the same type and a second level (“level-2”) involves arbitration across all types to pick a final winner. This scheme relies on credit checking after the level-1 arbitration to avoid starvation scenarios. The level-1 arbitration can track the available credits for each request type and ensures fair access to resources (e.g., access to the transmission medium, bandwidth, or the like) based on the available credits to ensure that all request types eventually gain access. However, the arbitration schemes that rely on allocation of credits to each credit type can increase the need for dedicated resources for each credit type. To minimize the need for dedicated resources for each credit type, the concept of shared credits were introduced in some arbitration schemes of some protocols, such as the Peripheral Component Interconnect Express (PCIe) protocol. However, the same two-level arbitration scheme above does not work when shared credits are used.

Aspects and embodiments of the present disclosure address these problems and others by providing credit checking with a minimum shared credit amount to address starvation scenarios described herein. The specified minimum amount of shared credits can be based on a maximum packet size supported by an interconnect circuit or a maximum packet size of packets waiting for arbitration in a current cycle. In particular, aspects and embodiments of the present disclosure can incorporate a minimum shared credit checking after the level-1 arbitration, and replace a round robin (RR) or weighted round robin (WRR) arbiter with fair arbiter, such as a Weighted Least Recently Used (WLRU) arbiter, in the level-2 arbitration. Both of these features combined can remove the starvation scenarios described herein. Although the PCIe specification defines the use of shared credits, aspects and embodiments of the present disclosure can change the way that credits are handled when they are shared. For example, at least one embodiment pertains to an interconnect circuit with a physical (PHY) layer and a data link layer with credit-check logic to block selected packets from selection responsive to a lack of available shared credits in a shared credit pool above a specified minimum amount of shared credits or a lack of available dedicated credits assigned to a traffic type.

It should be noted that various embodiments are described as being implemented in PCIe, but the technology described herein can be used by other protocols or between two blocks in the same chip where communication resources are being shared using shared credits. For example, two processing units (or other blocks in an integrated circuit) could use shared credits to avoid “per traffic type” buffering. For example, there can be ordered or unordered traffic types, such as read, write, and completions in communication protocols, such as PCIe. Instead of having each type have its own buffer (that is accounting for round-trip time), a single shared buffer can be used to save area. So, the technology of shared credits and a minimum shared credit can be used in other use cases than the PCIe protocol.

It should also be noted that although two level arbitration schemes have been used historically, aspects and embodiments of the present disclosure can be used in a single level arbitration scheme with WLRU (or other fair arbiter) and “minimum credit check” to avoid starvation and fairness problems.

Aspects and embodiments of the present disclosure can be used in any communication link. The communication link can be a Serializer-Deserializer (SerDes) link, an NVLink, cellular networking, PCIe, Ethernet, InfiniBand, Ground Reference Signal (GRS), Chip-to-Chip (C2C), Die-to-Die (D2D), LPI (low power interface) or LLI (low latency interface), Compute Express Link (CXL), Universal Chiplet Interconnect Express (UCIE), or the like. Aspects and embodiments of the present disclosure can be used in various applications, including communication applications.

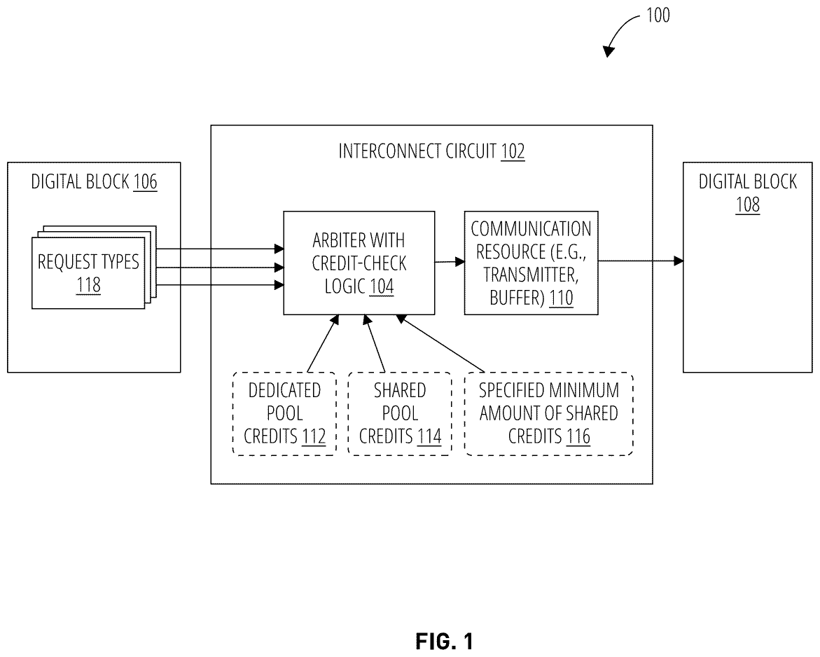

FIG. 1 is a block diagram of a communication system 100 having an interconnect circuit 102 with an arbiter with credit-check logic 104 that uses a specified minimum amount of shared credits according to at least one embodiment. The interconnect circuit 102 of the communication system 100 can be located between two digital blocks, digital block 106 and digital block 108, in an integrated circuit. In other embodiments, the two digital blocks are on separate integrated circuits, separated by a communication link. For example, the interconnect circuit 102 can implement the PCIe protocol to communication over the communication link. The digital block 106 and digital block 108 can each be any of the following: a processing unit, such as a central processing unit (CPU), a graphics processing unit (GPU), a microcontroller unit (MCU), a finite state machine (FSM), a control unit, a memory controller, a serial communication block, a parallel communication block, an arithmetic logic unit, a floating-point unit (FPU), a multiply-accumulate (MAC) unit, a bit manipulation unit, a cryptographic engine, a hardware security module (HSM), a neural processing unit (NPU), a tensor processing unit (TPU), a vector processing unit (VPU), an FPGA, a System on Chip (SoC), a direct memory access (DMA) controller, a wired or wireless networking component, a digital signal processor (DSP), a processor, a microprocessor, a portion of a processor, a data processing unit (DPU), a network device, a switch, a set of one or more computing resources, or the like.

In at least one embodiment, the interconnect circuit 102 can be used to facilitate communication between the digital block 106 and the digital block 108. Although illustrated as the digital block 106 sending data to the digital block 108, in other embodiments, the communication can be bi-directional. To send data, the digital block 106 can send packets. The digital block 106 can request to send a packet with the interconnect circuit 102. These requests can include different request types 118. The arbiter with credit-check logic 104 can receive the different request types from the digital block 106 and determine which request gets access to a shared communication resource 110. The arbiter with credit-check logic 104 can be implemented with combinational logic components, combinational logic, digital logic elements, or the like. In some embodiments, the arbiter with credit-check logic 104 can use a logic gate (referred to herein as credit gate (CG) that evaluates if a client can send a packet in a given cycle by evaluating the available credits and length of the requested packet. The shared communication resource 110 can be a transmitter, a buffer, or other types of communication resources that are used to send or receive data. In some cases, the shared communication resource 110 can be a portion of an available bandwidth, such as a resource block in a communication protocol. The arbiter with credit-check logic 104 can pass or blocks requests using dedicated pool credits 112, shared pool credits 114, and a specified minimum amount of shared credits 116. The dedicated pool credits 112 can specify a number or an amount of credits for each of the request types 118. The shared pool credits 114 can specify a number or an amount of credits that can be shared among the request types 118. The specified minimum amount of shared credits 116 can specify the minimum number or minimum amount of shared credits that need to be maintained in the shared pool credits 114. In at least one embodiment, the specified minimum amount of shared credits 116 can be derived from, or based on, a maximum packet size supported by the interconnect circuit 102. In at least one embodiment, the specified minimum amount of shared credits 116 can be derived from, or based on, a maximum packet size of packets waiting for arbitration in a current cycle. In at least one embodiment, these amounts can be specified in registers (or other memory) that are accessible by the arbiter with credit-check logic 104. These amounts can be defined or derived from information shared with the digital block 106 by the digital block 108.

In at least one embodiment, the arbiter with credit-check logic 104 can block one or more requests from being passed to the shared communication resource 110 responsive to determining i) a lack of available shared credits in a shared credit pool of the shared pool credits 114 above a specified minimum amount of shared credits 116, or ii) a lack of available dedicated credits assigned to the respective traffic type, as specified in the dedicated pool credits 112.

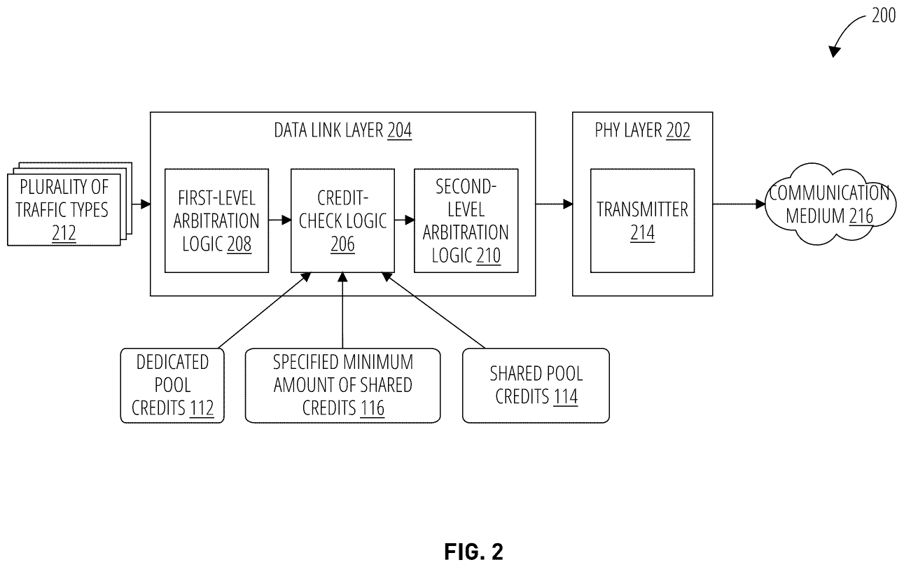

In at least one embodiment, the arbiter with credit-check logic 104 can be implemented in an interconnect circuit with a physical layer (PHY layer) and a data link layer (also referred to as link layer) that implements a communication protocol, such as the PCIe protocol, as illustrated and described below with respect to FIG. 2.

FIG. 2 is a block diagram of an interconnect circuit 200 with a PHY layer 202 and a data link layer 204 with credit-check logic 206 according to at least one embodiment. The PHY layer 202 includes a transmitter 214 that can send data over a communication medium 216 (e.g., air, wire, trace, or the like). The data link layer 204 includes the credit-check logic 206, which is coupled between a first-level arbitration logic 208 and a second-level arbitration logic 210. The first-level arbitration logic 208 can receive multiple requests of a plurality of traffic types 212. The first-level arbitration logic 208 can group the requests according to the plurality of traffic types 212. The first-level arbitration logic 208 can select one of the requests as a selected request to send a packet over a link (i.e., over the communication medium 216) for each of the plurality of traffic types 212. The credit-check logic 206 can receive, from the first-level arbitration logic 208 for each of the plurality of traffic types 212, the selected request. The credit-check logic 206 can use the dedicated pool credits 112, the shared pool credits 114, and the specified minimum amount of shared credits 116, to determine whether to pass or block requests from being passed from the first-level arbitration logic 208 to the second-level arbitration logic 210. In at least one embodiment, the credit-check logic 206 can determine whether there is a lack of available shared credits in a shared credit pool above a specified minimum amount of shared credits. The credit-check logic 206 can determine whether there is a lack of available dedicated credits assigned to the respective traffic type. In at least one embodiment, the credit-check logic 206 can block one or more requests from being passed from the first-level arbitration logic 208 to the second-level arbitration logic 210 responsive to determining i) a lack of available shared credits in a shared credit pool above a specified minimum amount of shared credits, or ii) a lack of available dedicated credits assigned to the respective traffic type.

In another embodiment, a transmitter device can include the credit-check logic 206. For example, a transmitter device can include a transmitter and a controller coupled to the transmitter. The controller can include the first-level arbitration logic 208, the second-level arbitration logic 210, and the credit-check logic 206. The first-level arbitration logic 208 can receive, from a plurality of clients, a plurality of requests to send packets, and provide a selected request for each of a plurality of traffic types (also referred to herein as client groups). The second-level arbitration logic 210 can select one of the selected requests from the first-level arbitration logic, and provide the one of the selected requests to the transmitter to send the respective packet. The credit-check logic 206 can be coupled between the first-level arbitration logic 208 and second-level arbitration logic 210. The credit-check logic 206 can receive the selected requests from the first-level arbitration logic 208, and, for each of the selected requests, either i) pass the respective selected request to the second-level arbitration logic 210 if a first value representing available shared credits in a shared credit pool is greater than a minimum value or a request length of the respective selected request is less than a second value representing available dedicated credits in a dedicated credit pool assigned to the respective traffic type, or ii) otherwise block the respective selected request from being passed to the second-level arbitration logic 210.

In a further embodiment, the controller can also include credit replenishment logic. The credit replenishment logic can specify a first fixed credit share for a first client group corresponding to a first traffic type, and a second fixed credit share for a second client group corresponding to a second traffic type. On a credit release of a set of credits from a link partner, the credit replenishment logic can equally distribute the set of credits across the first client group and the second client group. Responsive to the first client group reaching the first fixed credit share, the credit replenishment logic stops adding credits from the set of credits to the first client group. Responsive to the second client group reaching the second fixed credit share, the credit replenishment logic stops adding credits from the set of credits to the second client group. In at least one embodiment, the first client group corresponds to isochronous (iso) clients, and the second client group corresponds to non-isochronous (non-iso) clients.

In at least one embodiment, the controller can also include non-share based credit replenishment logic that adds the credits returned by a link partner to a dedicated credit pool or a shared credit pool.

In a further embodiment, the credit-check logic can include a first credit gate assigned to a first traffic type of the plurality of traffic types, and a second credit gate assigned to a second traffic type of the plurality of traffic types. The first credit gate can determine, for a first selected request received from the first-level arbitration logic 208, whether the first value is greater than the minimum value or whether the request length of the first selected request is less than or equal to the second value, representing an amount of available dedicated credits assigned to the first traffic type. The first credit gate can pass the first selected request to the second-level arbitration logic 210 responsive to the first value being greater than the minimum value or the request length of the first selected request being less than or equal to the second value. The second credit gate can determine, for a second selected request received from the first-level arbitration logic 208, whether the first value is greater than the minimum value or whether the request length of the second selected request is less than or equal to the second value, representing an amount of available dedicated credits assigned to the second traffic type. The second credit gate can pass the second selected request to the second-level arbitration logic 210 responsive to the first value being greater than the minimum value or the request length of the second selected request being less than or equal to the second value. The second-level arbitration logic 210 implements a WLRU arbitration scheme.

In at least one embodiment, an interconnect circuit includes a PHY layer comprising a transmitter, and a data link layer coupled to the PHY layer. The data link layer includes the first-level arbitration logic 208, the credit-check logic 206, and the second-level arbitration logic 210. The first-level arbitration logic 208 can receive, from a plurality of clients, a plurality of requests to send packets over a link, and provide a selected request for each of a plurality of traffic types. The credit-check logic 206 can receive the selected requests from the first-level arbitration logic and block one or more of selected requests from the second-level arbitration logic responsive to determining a lack of available dedicated credits assigned to the respective traffic type or a lack of available shared credits in a shared credit pool above a specified minimum amount of shared credits. The second-level arbitration logic 210 can select one of the selected requests received from the credit-check logic, and provide the one of the selected requests to the transmitter to send the respective packet over the link.

In at least one embodiment, a transmitter device includes a transmitter and a controller coupled to the transmitter. The controller includes arbitration logic that can receive, from a plurality of clients, a plurality of requests to send packets. In a first stage of arbitration, the arbitration logic can select a first request for each of a plurality of traffic types from the plurality of requests. The arbitration logic can determine whether the first request for each of a plurality of traffic types should be passed to or blocked from a second stage of arbitration using a criteria. The arbitration logic can pass the respective first request to the second stage of arbitration if a first value, representing an amount of available shared credits in a shared credit pool, is greater than a minimum value. The arbitration logic can pass the respective first request to the second stage of arbitration if a second value, representing a packet length, is less than or equal to a third value, representing an amount of available dedicated credits assigned to the respective traffic type. The arbitration logic can block the respective first request from the second stage of arbitration if the first value is not greater than the minimum value or the second value is greater than the third value. In the second stage of arbitration, the arbitration logic can select one of the first requests passed to the second stage of arbitration.

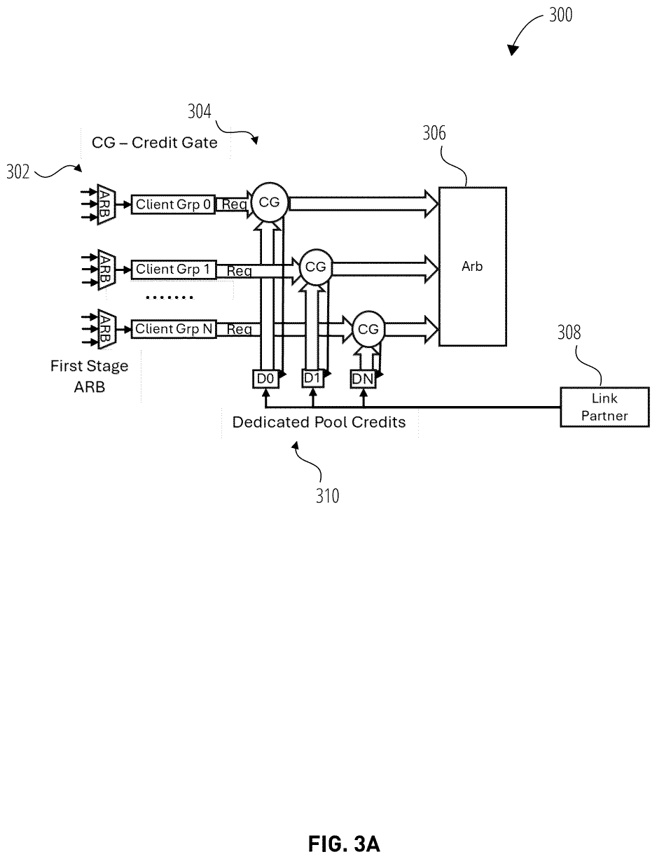

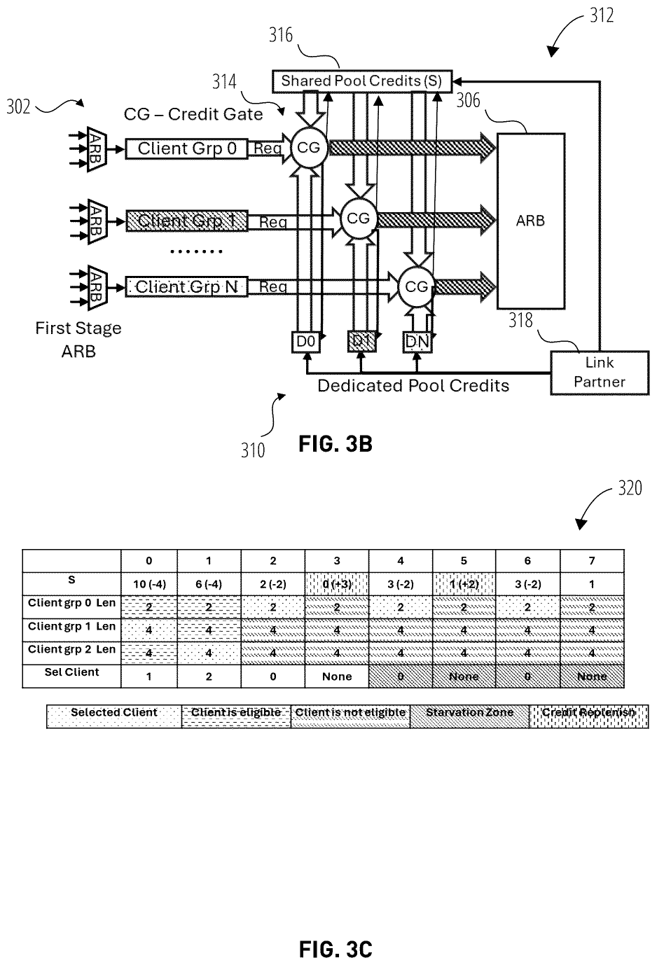

As described above, the controller, arbitration logic, or credit-check logic 206 described herein can use the specified minimum amount of shared credits 116. The use of the specified minimum amount of shared credits 116 can prevent starvation when shared credits are used, such as illustrated and described below with respect to FIG. 3A to FIG. 3C.

FIG. 3A is a block diagram of basic credit-based throttling logic 300 with dedicated credits per client according to one implementation. The credit-based throttling logic 300 includes first-level arbitration logic 302, credit gates 304, and second-level arbitration logic 306. The first-level arbitration logic 302 can receive requests from multiple traffic types (referred to as client groups or request types). The first-level arbitration logic 302 can select one of the requests from each of the traffic types and pass the selected request to a corresponding credit gate for evaluation. Each of the traffic types can have dedicated pool credits 310. The dedicated pool credits 310 can be allocated in a dedicated pool of credits for each of N number of client groups, where N is a positive integer greater than one. For example, a first client group (i.e., first traffic type) can be assigned a number of dedicated credits (D0), a second client group (i.e., second traffic type) can be assigned a number of dedicated credits (D1), and an Nth client group (i.e., Nth traffic type) can be assigned a number of dedicated credits (DN). The dedicated credits for each of the client groups can be assigned by a link partner 308, or derived from information received from the link partner 308. The link partner 308 can be a receiving entity of the packets being sent. Each of the credit gates 304 can evaluate if a client can send a packet in a given cycle by evaluating the available credits and length of the requested packet. If the credit gate 304 select a packet for a client, the client gate 304 can update the number of dedicated credits by the number of credits used by the client.

In scenarios where multiple clients are converged into N groups, the first-level arbitration logic 302 can be done agnostic of the credit situation. That is, the credit check by the credit gates 304 are applied after a first-stage arbitration by the first-level arbitration logic 302. If a credit check were applied before the first-stage arbitration, then it will lead to starvation in some conditions. One condition is where clients with small packets continue to win the arbitration when available credits for a group is small. In at least one embodiment, the credit check logic by each of the credit gates 304 is expressed in the following expressions:
CG logic:
Req_len_client_group_n<=Dn
   pass the request to Final Arb
else
   block this request

In the CG logic above, the Req_len_client_group_n is the request length of a packet for the corresponding client group (i.e., client group 0-N), and Dn represents the dedicated pool credits 310 for the corresponding client group. The “Final Arb” refers to the second-level arbitration logic 306. That is, if the request length for a packet request is less than the corresponding number of credits in the dedicated pool credits 310 for the client group, the request is passed to the second-level arbitration logic 306. If this condition is not met, the request is blocked by the respective credit gate 304. As described herein, the idea of shared credits was introduced to enable efficient utilization of credits across various traffic types. For example, the PCIe Gen6 standard uses shared credits, as illustrated in FIG. 3B.

FIG. 3B is a block diagram of credit-based throttling logic 312 with a mixed pool of shared pool credits 316 and dedicated pool credits 310 across clients according to one implementation. The credit-based throttling logic 312 is similar to credit-based throttling logic 300 of FIG. 3A as noted by similar reference numbers, except the dedicated pool credits 310 and the shared pool credits 316 can be assigned by a link partner 318, or derived from information received from the link partner 318. As described above, the shared pool credits 316 is a pool from which all client groups can fetch and use, whereas the dedicated pool credits 310 are exclusive for each client group.

In at least one embodiment, the credit check logic by each of the credit gates 314 can evaluate if a client can send a packet in a given cycle by evaluating two pools of credit, the dedicated pool credits 310 and shared pool credits 316. A client's request is forwarded by respective credit gate 314 to the second-level arbitration logic 306 (“Final Arb”) if there is enough credits in shared pool credits 316 or in the dedicated pool credits 310 in its respective dedicated credit pool. If a client fails to meet above criteria, the credit gates 314 blocks the request, i.e., the request is not forwarded to the second-level arbitration logic 306. In at least one embodiment, the credit check logic by each of the credit gates 314 is expressed in the following expressions:
CG Logic:
If Req_len_client_group_n<=S or Req_len_client_group_n<=Dn
   pass the request to Final Arb
else
   block this request

That is, if the request length for a packet request is less than the corresponding number of credits in the dedicated pool credits 310 for the client group or the request length is less than the number of shared credits in shared pool credits 316 for all client groups, the request is passed to the second-level arbitration logic 306. If this condition is not met, the request is blocked by the respective credit gate 314. As described herein, the idea of shared credits was introduced to enable efficient utilization of credits across various traffic types, however, the introduction of shared credits can lead to scenarios of starvation as illustrated and described below with respect to FIG. 3C.

FIG. 3C is a table 320 illustrating a starvation scenario caused by the credit-based throttling logic of FIG. 3B according to one implementation. As described above, shared credits can be used in the credit checking logic, but can cause starvation in scenarios where i) the dedicated credits are not available, and ii) the shared credits available in the shared pool credits 316 is small, and iii) the shared credits are replenished in smaller quantities, and iv) one client has requests that are less than the available shared credits (i.e., <S) and other clients have requests greater than the available shared credits (i.e., >S). That is, the clients with requests less than the available shared credits (i.e., <S) will be repeatedly selected, and it will keep consuming the small amount of replenished shared credits. This is demonstrated in the table 320. In this example, a first client (client 0) always has requests for two credits, while the other two clients each request four credits. Initially, there is enough credits to cater to all. But, after cycle 3, credits are replenished in smaller quantities which is always used by client 0 letting the other two clients starve.

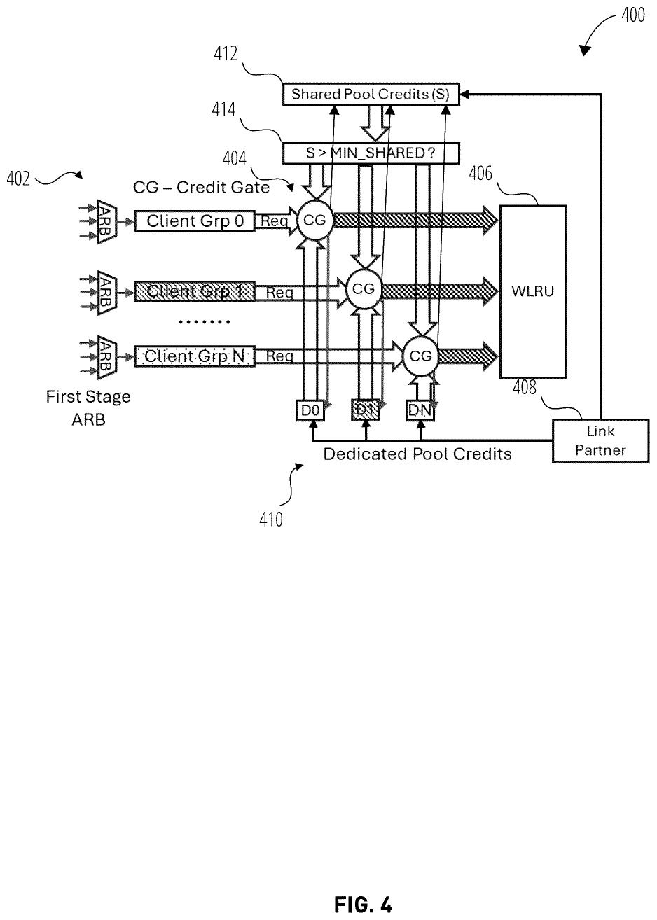

FIG. 4 is a block diagram of credit-based throttling logic 400 with a mixed pool of shared pool credits 412 with a specified minimum amount of shared credits 414 and dedicated pool credits 410 for multiple client groups according to at least one embodiment. In one embodiment, the specified minimum amount of shared credits 414 can be a fixed value. In other embodiments, the specified minimum amount of shared credits 414 can be dynamically negotiated and changed during initialization. The credit-based throttling logic 400 can avoid the starvation scenario described above by using a specified minimum amount of shared credits 414. In at least one embodiment, the specified minimum amount of shared credits 414 is defined based on a maximum packet size supported by the interconnect circuit. In at least one embodiment, the specified minimum amount of shared credits 414 is defined based on a maximum packet size of packets waiting for arbitration in a current cycle. In other embodiments, the specified minimum amount of shared credits 414 can be defined using other conditions that avoid the depletion of the shared pool credits 412 that are being shared across all client groups. In this embodiment, the dedicated pool credits 410 and the shared pool credits 412 can be assigned by a link partner 408, or derived from information received from the link partner 408. As described above, the shared pool credits 412 is a pool from which all client groups can fetch and use, whereas the dedicated pool credits 410 are exclusive for each client group. The credit-based throttling logic 400, unlike the credit-based throttling logic 300 and credit-based throttling logic 312, manages the shared pool credits 412.

In at least one embodiment, the credit check logic by each of the credit gates 404 can evaluate if a client can send a packet in a given cycle by evaluating whether the amount of available shared credits in the shared pool credits 412 is greater than the specified minimum amount of shared credits 414 or the request length is less than the amount of available dedicated credits in the dedicated pool credits 410. A client's request is forwarded by respective credit gate 404 to the second-level arbitration logic 406 (“Final Arb”) if there is enough credits in shared pool credits 412 above the specific specified minimum amount of shared credits 414 or if there is enough credits in the dedicated pool credits 410 in its respective dedicated credit pool. If a client fails to meet above criteria, the credit gates 404 blocks the request, i.e., the request is not forwarded to the second-level arbitration logic 406. In at least one embodiment, the credit check logic by each of the credit gates 404 is expressed in the following expressions:
CG Logic:
If (S>MIN_SHARED) or Req_len<=Dn
   pass the request to Final Arb
else
   block this request

One difference in this logic is that the request length is not compared with the shared pool credits 412, which is what causes starvation in the implementation set forth above. Instead if the available shared credits (S) is greater than the specified minimum amount of shared credits 414 (i.e., S>MIN_SHARED), then all client groups are deemed to be eligible for using the shared credits; otherwise, all credit groups are not eligible for using the shared credits. However, if the shared credit condition described previously is not met, the credit gates 404 can still pass a request if the request length is less than the available dedicated pool credits 410 in the respective dedicated credit pool for the given client group (i.e., req_len<=Dn). That is, if the request length for a packet request is less than the corresponding number of credits in the dedicated pool credits 410 for the client group or the number of shared credits in the shared pool credits 412 is greater than the specified minimum amount of shared credits 414, the request is passed to the second-level arbitration logic 406. If this condition is not met, the request is blocked by the respective credit gate 404. As such, the credit-based throttling logic 400 can enable efficient utilization of credits across various traffic types while avoiding starvation using the specified minimum amount of shared credits 414. In at least one embodiment, the specified minimum amount of shared credits 414 is the credit equivalent of the largest packet any of the client requests for a given cycle. In other embodiments, the specified minimum amount of shared credits 414 is the credit equivalent of the largest packet supported by an interconnect circuit in which the credit-based throttling logic 400 is implemented. It should be noted that the specified minimum amount of shared credits 414 can be held or not used from the shared pools when the condition is not met as a tradeoff to avoid starvation scenarios as described above. In particular, the credit-based throttling logic 400 can avoid the starvation scenario illustrated in the table 320 of FIG. 3C.

In at least one embodiment, the second-level arbitration logic 406 can implement a Weighted Least Recently Used (WLRU) arbitration scheme. In at least one embodiment, the second-level arbitration logic 406 can implement other types of fair arbitration schemes.

Also, although illustrated with two levels of arbitration, the credit-based throttling logic 400 can be used in a single level arbitration scheme. For example, the WLRU along with the minimum credit check against the specified minimum amount of shared credits 414 can be used to avoid starvation and fairness problems.

In at least one embodiment, the credit-based throttling logic 400 is implemented in a data link layer of an interconnect circuit that implements the PCIe protocol. In at least one embodiment, the credit-based throttling logic 400 is implemented in a link layer of an interconnect circuit that implements a communication protocol. In at least one embodiment, the credit-based throttling logic 400 is implemented in other sharing resources to exchange information between two blocks in the same chip, or between two chips. For example, two units that are far away from each other could use shared credits to avoid “per traffic type” buffering. For example, in PCIe there are ordered traffic types, including read, write, and completions. Similarly, there can be unordered versions of read, write, and completions in other contexts. In at least one embodiment, instead of having each type have its own buffer (that accounts for round-trip time), a single shared buffer can be used to save area. As such, the credit-based throttling logic 400 that manages shared credits can be used in other use cases than communication protocols, such as the PCIe protocol.

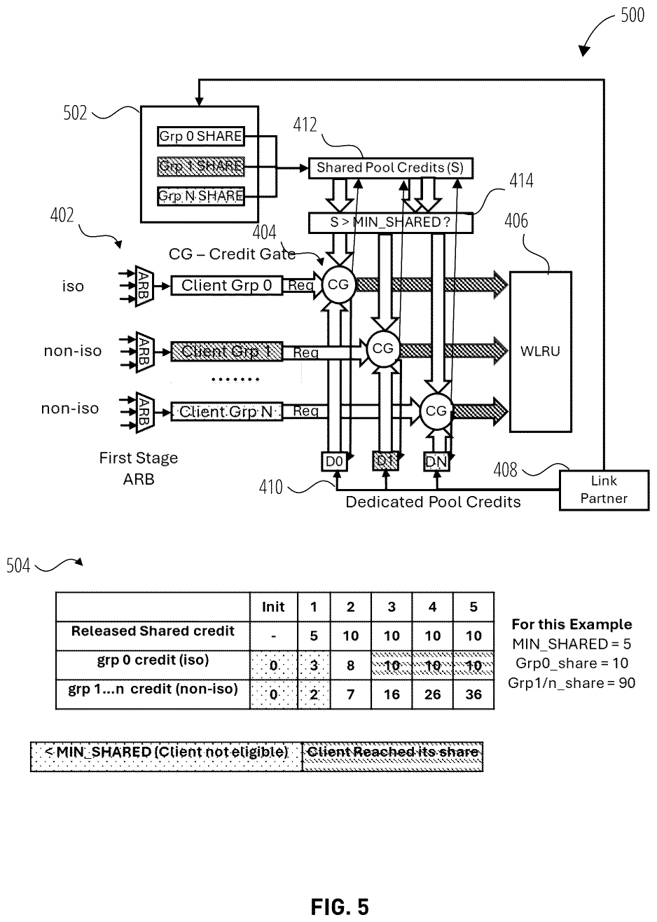

FIG. 5 is a block diagram of credit-based throttling logic 500 with credit replenishment logic 502 for the mixed pool of shared pool credits 412 with the specified minimum amount of shared credits 414 and dedicated pool credits 410 for multiple client groups according to at least one embodiment. The credit-based throttling logic 500 is similar to the credit-based throttling logic 400 of FIG. 4A, as noted by similar reference numbers, except the credit-based throttling logic 500 includes the credit replenishment logic 502 to replenish the shared pool credits 412 depending on a type of client. There are special cases where some clients that need to be guaranteed a certain bandwidth (or other access to shared resources). For example, isochronous (iso) clients, though they use a small bandwidth, need a guaranteed bandwidth. When this is not guaranteed, higher bandwidth clients (i.e., non-iso clients) may end up using all the bandwidth starving the iso clients. These special cases can use the credit replenishment logic to ensure proper allocations of the shared pool credits 412.

As described above, the dedicated pool credits 410 and the shared pool credits 412 can be assigned by the link partner 408, or derived from information received from the link partner 408. As described above, the shared pool credits 412 is a pool from which all client groups can fetch and use, whereas the dedicated pool credits 410 are exclusive for each client group. The credit-based throttling logic 500, unlike the credit-based throttling logic 400, further manages the shared pool credits 412 using the credit replenishment logic 502 and the check against the specified minimum amount of shared credits 414.

In at least one embodiment, the credit replenishment logic 502 can specify a first fixed credit share for a first client group corresponding to a first traffic type (e.g., iso client for group 0), and a second fixed credit share for a second client group corresponding to a second traffic type (e.g., non-iso clients for groups 1-N). For example, the first fixed credit share can be 10credits and the second fixed credit share can be 90 credits, where 100 shared credits are to be used. On a credit release of a set of credits from the link partner 408, the credit replenishment logic 502 equally distributes the set of credits across the first client group and the second client group. However, responsive to the first client group reaching the first fixed credit share (e.g., 10), the credit replenishment logic 502 stops adding credits from the set of credits to the first client group. Responsive to the second client group reaching the second fixed credit share, the credit replenishment logic 502 stops adding credits from the set of credits to the second client group. In other embodiments, other numbers of credits can be specified for more than two groups.

As illustrated in table 504, after cycle 3, the iso client (group 0) has reached the first fixed credit share of 10 credits. The remaining credits in cycle 3 and subsequent cycles are added to the non-iso clients for groups 1-N.

In at least one embodiment, the credit replenishment logic 502 can be used in connection with the credit checking of the specified minimum amount of shared credits 414. In this example, since the number of shared credits in cycle 1 are less than the specified minimum amount of shared credits 414, none of the client groups are eligible for shared credits. This scheme and the specified minimum amount of shared credits 414 can avoid starvation in mixed iso/non-iso traffic scenarios.

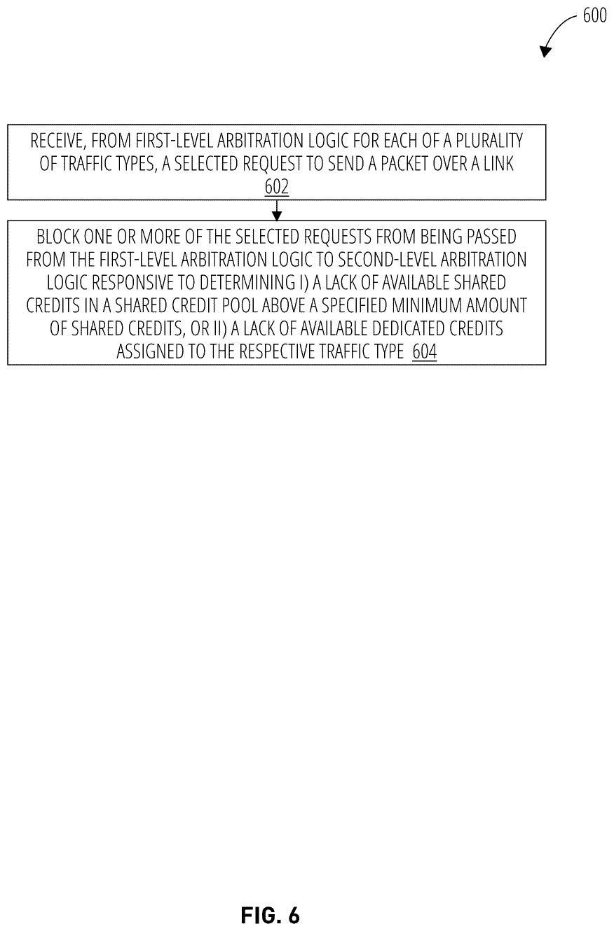

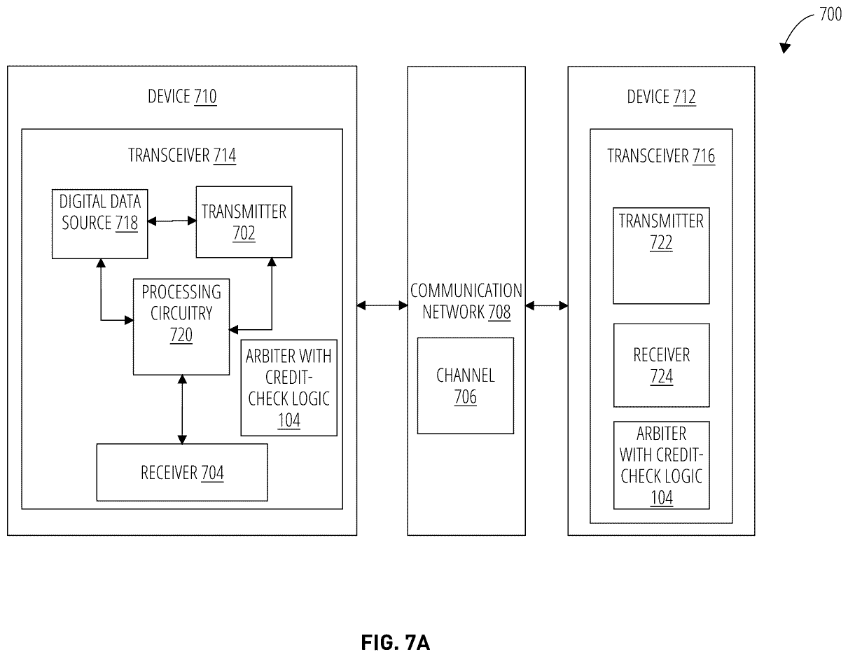

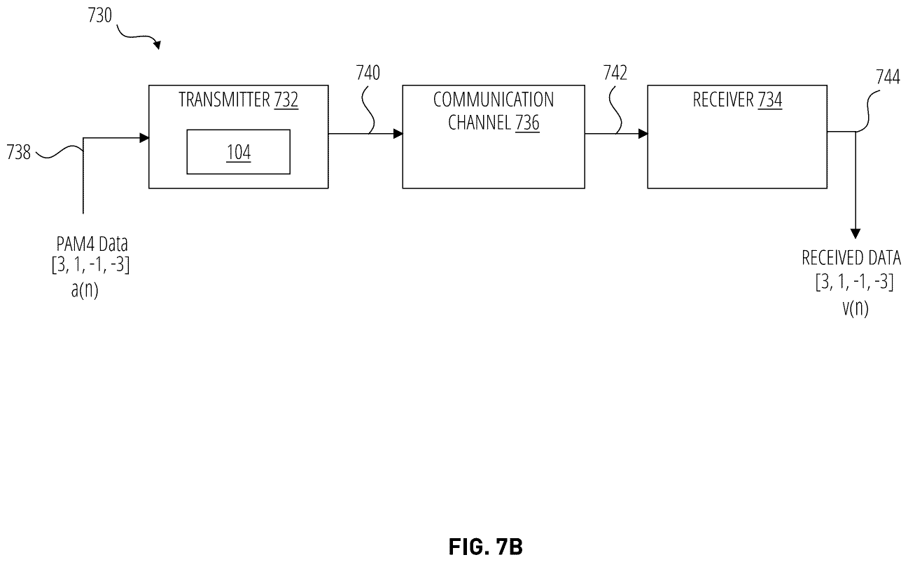

FIG. 6 is a flow diagram of an example method 600 arbitrating packet requests using a specified minimum amount of shared credits according to at least one embodiment. Method 600 can be performed using one or more processing units (e.g., CPUs, GPUs, accelerators, physics processing units (PPUs), data processing units (DPUs), etc.), which may include (or communicate with) one or more memory devices. In at least one embodiment, method 600 can be performed using a processing device or processing devices. The method 600 may be performed by processing logic that may comprise hardware (e.g., circuitry, dedicated logic, programmable logic, microcode, etc.), software (e.g., instructions run on a processing device to perform hardware simulation), or a combination thereof. In at least one embodiment, method 600 can be performed using processing units of interconnect circuit 102 of FIG. 1. In at least one embodiment, the method 600 can be performed using the arbiter with credit-check logic 104 of FIG. 1. In at least one embodiment, method 600 can be performed using processing units of interconnect circuit 200 of FIG. 2. In at least one embodiment, the method 600 can be performed by credit-check logic 206 of FIG. 2. The method 600 can be performed by credit-based throttling logic 400 of FIG. 4 or credit-based throttling logic 500 of FIG. 5. In at least one embodiment, processing units performing the method 600 can be executing instructions stored on a non-transient computer readable storage media. In at least one embodiment, the method 600 can be performed using multiple processing threads (e.g., CPU threads and/or GPU threads), individual threads executing one or more individual functions, methods, subroutines, or operations of the method. In at least one embodiment, processing threads implementing any of method 600 can be synchronized (e.g., using semaphores, critical sections, and/or other thread synchronization mechanisms). Alternatively, processing threads implementing the method 600 can be executed asynchronously with respect to each other. Various operations of method 600 can be performed in a different order compared with the order shown in FIG. 7. Some operations of the method 600 can be performed concurrently with other operations. In at least one embodiment, one or more operations shown in FIG. 6 may not always be performed. The method 600 can be performed by other devices described herein.

Referring to FIG. 6, the method 600 begins with the processing logic receiving, from first-level arbitration logic for each of a plurality of traffic types, a selected request to send a packet over a link (block 602). At block 604, the processing logic blocks one or more of the selected requests from being passed from the first-level arbitration logic to second-level arbitration logic responsive to determining i) a lack of available shared credits in a shared credit pool above a specified minimum amount of shared credits, or ii) a lack of available dedicated credits assigned to the respective traffic type. In at least one embodiment, the second-level arbitration logic implements a WLRU arbitration scheme.

In another embodiment, the method 600 includes receiving a plurality of requests from a plurality of traffic types. The processing logic arbitrates the requests using two pools of credits, including a dedicated credit pool for the respective traffic type, and a shared credit pool. The processing logic can check the available shared credits in the shared credit pool against a specified minimum amount of shared credits to avoid starvation, as described herein.

In a further embodiment, the processing logic passes one or more of the selected requests received from the first-level arbitration logic to the second-level arbitration logic responsive to determining iii) an availability of shared credits in the shared credit pool above the specified minimum amount of shared credits, or iv) an availability of dedicated credits assigned to the respective traffic type.

In at least one embodiment, the processing logic receives, at the first-level arbitration logic from a plurality of clients, a plurality of requests to send packets over the link. The processing logic selects, at the second-level arbitration logic, a request from the one or more selected requests passed from the first-level arbitration logic. The processing logic sends the packet, corresponding to the request, over the link.

In at least one embodiment, selecting the request includes selecting the request from the one or more selected requests using a WLRU arbitration scheme.

In at least one embodiment, the processing logic determines i) the lack of available dedicated credits assigned to the respective traffic type by determining that a first value, representing an amount of available shared credits in the shared credit pool, is not greater than the specified minimum amount. In at least one embodiment, the processing logic determines ii) the lack of available dedicated credits assigned to the respective traffic type by determining that a second value, representing a request length of the respective selected request, is greater than a third value, representing an amount of available dedicated credits assigned to the respective traffic type.

In at least one embodiment, the processing logic determines, using a first credit gate assigned to a first traffic type of the plurality of traffic types for a first selected request received from the first-level arbitration logic, whether a first value, representing an amount of available shared credits in the shared credit pool, is greater than the specified minimum amount or whether a second value, representing a request length of the first selected request, is less than or equal to a third value, representing an amount of available dedicated credits assigned to the first traffic type. The processing logic passes, using the first credit gate, the first selected request to the second-level arbitration logic responsive to the first value being greater than the specified minimum amount or the second value being less than or equal to the third value. The processing logic determines, using a second credit gate assigned to a second traffic type of the plurality of traffic types, for a second selected request received from the first-level arbitration logic, whether the first value is greater than the specified minimum amount or whether a fourth value, representing a request length of the second selected request, is less than or equal to a fifth value, representing an amount of available dedicated credits assigned to the second traffic type. The processing logic passes, using second credit gate, the second selected request to the second-level arbitration logic responsive to the first value being greater than the specified minimum amount or the fourth value being less than or equal to the fifth value.

In at least one embodiment, the processing logic specifies a first fixed credit share for a first client group corresponding to a first traffic type. The processing logic specifies a second fixed credit share for a second client group corresponding to a second traffic type. On a credit release of a set of credits from a link partner, the processing logic equally distributes the set of credits across the first client group and the second client group. Responsive to the first client group reaching the first fixed credit share, the processing logic stops an addition of credits from the set of credits to the first client group. Responsive to the second client group reaching the second fixed credit share, the processing logic stops an addition of credits from the set of credits to the second client group.

FIG. 7A illustrates an example communication system 700 with an arbiter with credit-check logic 104, in accordance with at least some embodiments. The communication system 700 includes a device 710, a communication network 708 including a communication channel 706, and a device 712. In at least one embodiment, the devices 710 and 712 are integrated circuits of a Personal Computer (PC), a laptop, a tablet, a smartphone, a server, a collection of servers, or the like. In some embodiments, the devices 710 and 712 may correspond to any appropriate type of device that communicates with other devices also connected to a common type of communication network 708. According to embodiments, the transmitter 702 and 722 of devices 710 or 712 may correspond to transmitters of a Graphics Processing Unit (GPU), a switch (e.g., a high-speed network switch), a network adapter, a central processing unit (CPU), a data processing unit (DPU), etc.

Examples of the communication network 708 that may be used to connect the devices 710 and 712 include wires, conductive traces, bumps, terminals, optical fibers, or the like. In other embodiments, the communication network 708 can be a Peripheral Component Interconnect Express (PCIe) interconnect. PCIe is a high-speed interface standard used to connect various hardware components. It can be an interconnect for devices such as graphics cards (GPUs), solid-state drives (SSDs), network cards, and other peripherals. PCIe offers a scalable, high-speed, and point-to-point connection between devices, including CPUs, GPUs, memory, and the like. In other embodiments, the communication network 708 can be a high-speed interconnect, such as an interconnect that deploys the NVLink technology. The NVLink interconnect can be a GPU-GPU interconnect used between GPUs, a CPU-GPU interconnect between GPUs and CPUs, or an interconnect used between other devices. NVLink offers a higher bandwidth and lower latency than traditional PCIe connections, which are typically used in computing hardware. NVLink is especially useful in scenarios that require massive parallel processing, such as artificial intelligence (AI), machine learning, deep learning, high-performance computing (HPC), and data analytics. For example, in NVIDIA's DGX systems and high-end gaming or AI workstations, NVLink helps GPUs exchange data at speeds that are necessary for demanding tasks like real-time ray tracing or training neural networks. In one specific, but non-limiting example, the communication network 708 is a network that enables data transmission between the devices 710 and 712 using data signals (e.g., digital, optical, wireless signals), clock signals, or both. The embodiments described herein can be utilized in a system with a high-speed, scalable switch, such as a switch using the NVSwitch technology. NVSwitch is a high-speed, scalable switch developed by NVIDIA that facilitates data communication between multiple GPUs in a system, allowing them to work together more efficiently by providing high-bandwidth, low-latency interconnections. The NVSwitch serves as a central hub or high-bandwidth fabric that interconnects all the GPUs in a system, enabling each GPU to communicate with every other GPU quickly and efficiently. The NVSwitch can be coupled between other types of devices, such as CPUs, accelerators, memory, or the like. The NVSwitch can be used for tasks requiring intense computation and collaboration between multiple GPUs, such as AI model training, scientific simulations, and large-scale data processing. The embodiments described herein can be used in a high-performance computing system, such as a computing system modeled after NVIDIA's DGX systems, which are designed specifically for artificial intelligence (AI), deep learning, and high-performance computing (HPC) workloads. DGX systems are optimized for large-scale GPU computation and parallel processing, integrating multiple GPUs, high-bandwidth interconnects, and software frameworks tailored for AI and HPC tasks. In at least one embodiment, a system for high-speed network communication includes a processing unit, a network interface comprising a transmitter or transceiver with the arbiter with credit-check logic 104. In at least one embodiment, a system for high-speed network communication includes a processing unit, a network interface comprising a transmitter or transceiver with the arbiter with credit-check logic 104, as described herein. The processing unit can include a CPU, a GPU, a DPU, a network adapter, a network switch, an NVLink switch, or the like. 2436, as described herein.

Other examples for the communication network 708 can include other chip-to-chip or die-to-die interconnects, such as GRS, LPI (low power interface) or LLI (low latency interface).

The device 710 includes a transceiver 714 for sending and receiving signals, for example, data signals. The data signals may be digital or optical signals modulated with data or other suitable signals for carrying data.

The transceiver 714 may include a digital data source 718, a transmitter 2402, a receiver 704, and processing circuitry 720 that controls the transceiver 714. The digital data source 718 may include suitable hardware and/or software for outputting data in a digital format (e.g., in binary code and/or thermometer code). The digital data output by the digital data source 718 may be retrieved from memory (not illustrated) or generated according to input (e.g., user input). The transceiver 714 can include the arbiter with credit-check logic 104 as described above with respect to FIG. 1 to FIG. 6.

The transceiver 714 includes suitable software and/or hardware for receiving digital data from the digital data source 718 and outputting data signals according to the digital data for transmission over the communication network 708 to a transceiver 716 of device 712.

The receiver 704 of device 710 may include suitable hardware and/or software for receiving signals, for example, data signals from the communication network 708. For example, the receiver 704 may include components for receiving processing signals to extract the data for storing in a memory. In at least one embodiment, the transceiver 716 includes a transmitter 722 and receive 734. The transceiver 716 receives an incoming signal and samples the incoming signal to generate samples, such as using an analog-to-digital converter (ADC). The ADC can be controlled by a clock-recovery circuit (or clock recovery block) in a closed-loop tracking scheme. The clock-recovery circuit can include a controlled oscillator, such as a voltage-controlled oscillator (VCO) or a digitally-controlled oscillator (DCO) that controls the sampling of the subsequent data by the ADC. The transceiver 716 can include the arbiter with credit-check logic 104 as described above with respect to FIG. 1 to FIG. 6

The processing circuitry 720 may comprise software, hardware, or a combination thereof. For example, the processing circuitry 720 may include a memory including executable instructions and a processor (e.g., a microprocessor) that executes the instructions on the memory. The memory may correspond to any suitable type of memory device or collection of memory devices configured to store instructions. Non-limiting examples of suitable memory devices that may be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory). Additionally or alternatively, the processing circuitry 720 may comprise hardware, such as an Application-Specific Integrated circuit (ASIC). Other non-limiting examples of the processing circuitry 720 include an Integrated Circuit (IC) chip, a CPU, A GPU, a DPU, a microprocessor, a Field-Programmable Gate Array (FPGA), a collection of logic gates or transistors, resistors, capacitors, inductors, diodes, or the like. Some or all of the processing circuitry 720 may be provided on a Printed Circuit Board (PCB) or collection of PCBs. It should be appreciated that any appropriate type of electrical component or collection of electrical components may be suitable for inclusion in the processing circuitry 720. The processing circuitry 720 may send and/or receive signals to and/or from other elements of the transceiver 714 to control the overall operation of the transceiver 714.

The transceiver 714 or selected elements of the transceiver 714 may take the form of a pluggable card or controller for the device 710. For example, the transceiver 714 or selected elements of the transceiver 714 may be implemented on a network interface card (NIC).

The device 712 may include a transceiver 716 for sending and receiving signals, for example, data signals over a channel 706 of the communication network 708. The channel 706 can be PCIe, NVLink, Ethernet, InfiniBand, Ground Reference Signal (GRS), Chip-to-Chip (C2C), Die-to-Die (D2D), or the like. The same or similar structure of the transceiver 714 may be applied to transceiver 716, and thus, the structure of transceiver 716 is not described separately. In particular, the transceiver 716 can include the transmitter 722, receiver 724, and arbiter with credit-check logic 104.

Although not explicitly shown, it should be appreciated that devices 710 and 712 and the transceiver 714 and transceiver 716 may include other processing devices, storage devices, and/or communication interfaces generally associated with computing tasks, such as sending and receiving data.

FIG. 7B illustrates a block diagram of an example communication system 730 employing a transmitter 732 with the arbiter with credit-check logic 104, according to at least one embodiment. In the example shown in FIG. 7B, a Pulse Amplitude Modulation level-4 (PAM4) modulation scheme is employed with respect to the transmission of a signal (e.g., digitally encoded data) from a transmitter (TX) 732 to a receiver (RX) 734 via a communication channel 736 (e.g., a transmission medium). The communication channel 736 can be PCIe, NVLink, Ethernet, InfiniBand, GRS, C2C, D2D, or the like. In this example, the transmitter 732 receives input data 738 (i.e., the input data at time n is represented as “a(n)”), which is modulated in accordance with a modulation scheme (e.g., PAM4) and sends the signal 740 a(n) including a set of data symbols (e.g., symbols −3, −1, 1, 3, where the symbols represent coded binary data). It is noted that while the use of the PAM4 modulation scheme is described herein by way of example, other data modulation schemes can be used in accordance with embodiments of the present disclosure, including for example, a non-return-to-zero (NRZ) modulation scheme, PAM3, PAM7, PAM8, PAM16, etc. For example, for an NRZ-based system, the transmitted data symbols consist of symbols −1 and 1, with each symbol value representing a binary bit. This is also known as a PAM level-2 or PAM2 system as there are 2 unique values of transmitted symbols. Typically, a binary bit 0 is encoded as −1, and a bit 1 is encoded as 1 as the PAM2 values.

In the example shown, the PAM4 modulation scheme uses four (4) unique values of transmitted symbols to achieve higher efficiency and performance. The four levels are denoted by symbol values −3, −1, 1, 3, with each symbol representing a corresponding unique combination of binary bits (e.g., 00, 01, 10, 11).

The communication channel 736 is a destructive medium in that the channel acts as a low pass filter which attenuates higher frequencies more than it attenuates lower frequencies, introduces inter-symbol interference (ISI) and noise from cross talk, from power supplies, from Electromagnetic Interference (EMI), or from other sources. The communication channel 736 can be over serial links (e.g., a cable, PCB traces, copper cables, optical fibers, or the like), read channels for data storage (e.g., hard disk, flash solid-state drives (SSDs), high-speed serial links, deep space satellite communication channels, applications, or the like. The receiver (RX) 734 receives an incoming signal 742 over the communication channel 736. The receiver 734 can output a received signal 744, “v(n),” including the set of data symbols (e.g., symbols −3, −1, 1, 3, wherein the symbols represent coded binary data).

In at least one embodiment, the transmitter 732 can be part of a SerDes IC. The SerDes IC can be a transceiver that converts parallel data to serial data and vice versa. The SerDes IC can facilitate transmission between two devices over serial streams, reducing the number of data paths, wires/traces, terminals, etc. The receiver 734 can be part of a SerDes IC. The SerDes IC can include a clock-recovery circuit. The clock-recovery circuit can be coupled to an ADC and an equalization block. In another embodiment, the SerDes IC can include additional equalization block before a symbol detector.

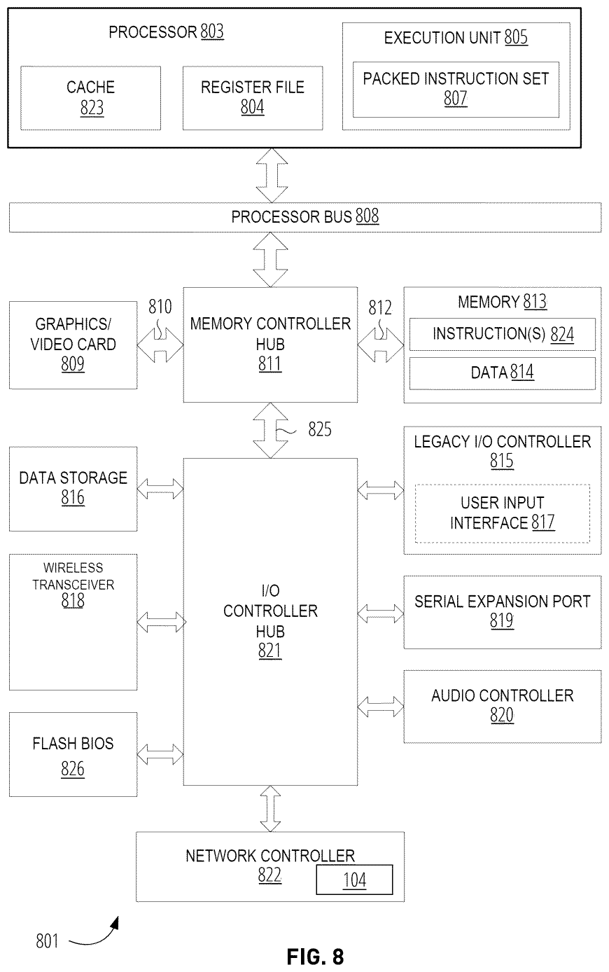

FIG. 8 illustrates an example computer system 801, including an error correction circuit 830, in accordance with at least some embodiments. In at least one embodiment, computer system 801 may be a system with interconnected devices and components, an SOC, or some combination. In at least one embodiment, computer system 801 is formed with a processor 803 that may include execution units to execute an instruction. In at least one embodiment, computer system 801 may include, without limitation, a component, such as a processor 803, to employ execution units including logic to perform algorithms for processing data. In at least one embodiment, computer system 801 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 801 may execute a version of WINDOWS' operating system available from Microsoft Corporation of Redmond, Wash., although other operating systems (UNIX and Linux, for example), embedded software, and/or graphical user interfaces, may also be used.

In at least one embodiment, computer system 801 may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (DSP), an SoC, network computers (“NetPCs”), set-top boxes, network hubs, wide area network (“WAN”) switches, or any other system that may perform one or more instructions. In an embodiment, computer system 801 may be used in devices such as graphics processing units (GPUs), network adapters, central processing units, and network devices such as switches (e.g., a high-speed direct GPU-to-GPU interconnect such as the NVIDIA GH100 NVLINK or the NVIDIA Quantum 2 64 Ports InfiniBand NDR Switch).

In at least one embodiment, computer system 801 may include, without limitation, processor 803 that may include, without limitation, one or more execution units 805 that may be configured to execute a Compute Unified Device Architecture (“CUDA”) (CUDA® is developed by NVIDIA Corporation of Santa Clara, CA) program. In at least one embodiment, a CUDA program is at least a portion of a software application written in a CUDA programming language. In at least one embodiment, computer system 801 is a single processor desktop or server system. In at least one embodiment, computer system 801 may be a multiprocessor system. In at least one embodiment, processor 803 may include, without limitation, a CISC microprocessor, a RISC microprocessor, a VLIW microprocessor, and a processor implementing a combination of instruction sets, or any other processor device, such as a digital signal processor, for example. In at least one embodiment, processor 803 may be coupled to a processor bus 808 that may transmit data signals between processor 803 and other components in computer system 801.

In at least one embodiment, processor 803 may include, without limitation, a Level 1 (“L1”) internal cache memory (“cache”) 823. In at least one embodiment, processor 803 may have a single internal cache or multiple levels of internal cache. In at least one embodiment, cache memory may reside external to processor 803. In at least one embodiment, processor 803 may also include a combination of both internal and external caches. In at least one embodiment, a register file 804 may store different types of data in various registers including, without limitation, integer registers, floating point registers, status registers, and instruction pointer register.

In at least one embodiment, execution unit 805, including, without limitation, logic to perform integer and floating point operations, also resides in processor 803. Processor 803 may also include a microcode (“ucode”) read only memory (“ROM”) that stores microcode for certain macro instructions. In at least one embodiment, execution unit 805 may include logic to handle a packed instruction set 807. In at least one embodiment, by including packed instruction set 807 in an instruction set of a general-purpose processor 803, along with associated circuitry to execute instructions, operations used by many multimedia applications may be performed using packed data in a general-purpose processor 803. In at least one embodiment, many multimedia applications may be accelerated and executed more efficiently by using full width of a processor's data bus for performing operations on packed data, which may eliminate a need to transfer smaller units of data across a processor's data bus to perform one or more operations one data element at a time.

In at least one embodiment, execution unit 806 may also be used in microcontrollers, embedded processors, graphics devices, DSPs, and other types of logic circuits. In at least one embodiment, computer system 801 may include, without limitation, a memory 813. In at least one embodiment, memory 813 may be implemented as a DRAM device, an SRAM device, flash memory device, or other memory devices. Memory 813 may store instruction(s) 824 and/or data 814 represented by data signals that may be executed by processor 803.

In at least one embodiment, a system logic chip may be coupled to a processor bus 808 and memory 813. In at least one embodiment, the system logic chip may include, without limitation, a memory controller hub (“MCH”) 811, and processor 803 may communicate with MCH 811 via processor bus 808. In at least one embodiment, MCH 811 may provide a high bandwidth memory path 812 to memory 813 for instruction and data storage and for storage of graphics commands, data, and textures. In at least one embodiment, MCH 811 may direct data signals between processor 803, memory 813, and other components in computer system 801 and may bridge data signals between processor bus 808, memory 813, and a system I/O 825. In at least one embodiment, a system logic chip may provide a graphics port for coupling to a graphics controller. In at least one embodiment, MCH 811 may be coupled to memory 813 through high bandwidth memory path 812, and graphics/video card 809 may be coupled to MCH 811 through an Accelerated Graphics Port (“AGP”) interconnect 810.

In at least one embodiment, computer system 801 may use system I/O 825 that is a proprietary hub interface bus to couple MCH 811 to I/O controller hub (“ICH”) 821. In at least one embodiment, ICH 821 may provide direct connections to some I/O devices via a local I/O bus. In at least one embodiment, a local I/O bus may include, without limitation, a high-speed I/O bus for connecting peripherals to memory 813, a chipset, and processor 803. Examples may include, without limitation, an audio controller 820, a firmware hub (“flash BIOS”) 726, a wireless transceiver 818, a data storage 816, a legacy I/O controller 815 containing a user input interface 817, a keyboard interface, a serial expansion port 819, such as a USB, and a network controller 822. In at least one embodiment, the network controller 822 includes the arbiter with credit-check logic 104, as described herein. Data storage 816 may comprise a hard disk drive, a floppy disk drive, a CD-ROM device, a flash memory device, or other mass storage device.

In at least one embodiment, FIG. 8 illustrates a system, which includes interconnected hardware devices or “chips.” In at least one embodiment, FIG. 8 may illustrate an example SoC. In at least one embodiment, devices illustrated in FIG. 8 may be interconnected with proprietary interconnects, standardized interconnects (e.g., PCIe), or some combination thereof. In at least one embodiment, one or more components of system 802 are interconnected using compute express link (“CXL”) interconnects.

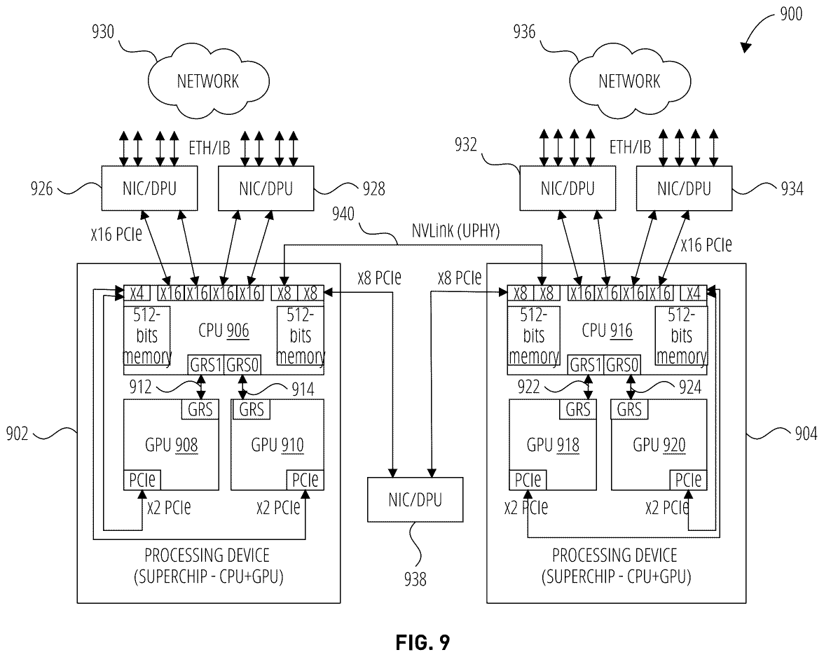

FIG. 9 is a block diagram of a computing system 900 having two processing devices coupled to each other and multiple networks according to at least one embodiment. The computing system 900 is designed with multiple integrated circuits (referred to as processing devices), where each integrated circuit includes a CPU and two GPUs, forming a powerful and flexible architecture. These processing devices are interconnected via an NVLink (or other high-speed interconnect), enabling high-speed communication between the processing devices, and are also connected through a Network Interface Card (NIC) or Data Processing Unit (DPU) to ensure efficient data transfer across the computing system 900. The coupling of processing devices through NVLink allows for seamless data exchange and parallel processing, enhancing overall computational performance. Additionally, these processing devices are connected to multiple networks through one or more network interface cards (NICs) or DPUs, enabling the system to handle complex, multi-network tasks with high bandwidth and low latency. This configuration makes the computing system 900 highly suitable for demanding applications that require significant processing power, such as artificial intelligence (AI), machine learning (ML), and data-intensive computing, while ensuring robust connectivity and scalability across various networked environments. The integrated circuits of the computing system 900 can include one or more CPUs and one or more GPUs. An example architecture of a multi-GPU architecture is illustrated in FIG. 9.

As illustrated in FIG. 9, the computing system 900 includes a processing device 902 with a multi-GPU architecture. In particular, the processing device 902 includes a CPU 906, a GPU 908, and a GPU 910. The CPU 906 can be coupled to the GPU 908 via an die-to-die (D2D) or chip-to-chip (C2C) interconnect 912, such as a Ground-Referenced Signaling interconnect (GRS interconnect). The CPU 906 can be coupled to the GPU 910 via a D2D or C2C interconnect 914. The CPU 906 can also couple to the GPU 908 and GPU 910 via PCIe interconnects. The CPU 906 can be coupled to one or more network interface cards (NICs) or data processing units (DPUs), which are coupled to one or more networks. For example, as illustrated in FIG. 9, the CPU 906 is coupled to a first NIC/DPU 926, which is coupled to a network 930. The CPU 906 is also coupled to a second NIC/DPU 928, which is coupled to the network 930. The NIC/DPU 926 and NIC/DPU 928 can be coupled to the network 930 over Ethernet (ETH) or InfiniBand (IB) connections.

The computing system 900 also includes a processing device 904 with a multi-GPU architecture. In particular, the processing device 904 includes a CPU 916, a GPU 918, and a GPU 920. The CPU 916 can be coupled to the GPU 918 via an D2D or C2C interconnect 922. The CPU 916 can be coupled to the GPU 920 via a D2D or C2C interconnect 924. The CPU 916 can also couple to the GPU 918 and GPU 920 via PCIe interconnects. The CPU 916 can be coupled to one or more NICs or DPUs, which are coupled to one or more networks. For example, as illustrated in FIG. 9, the CPU 916 is coupled to a first NIC/DPU 932, which is coupled to a network 936. The CPU 916 is also coupled to a second NIC/DPU 934, which is coupled to the network 936. The NIC/DPU 932 and NIC/DPU 934 can be coupled to the network 936 over Ethernet (ETH) or InfiniBand (IB) connections.

In at least one embodiment, the processing device 902 and the processing device 904 can communication with each other via a NIC/DPU 938, such as over PCIe interconnects. The processing device 902 and processing device 904 can also communicate with each other over a high-bandwidth communication interconnects 940, such as an NVLink interconnect or other high-speed interconnects. The NIC/DPUs of FIG. 9 can be the various embodiments of the DPUs described herein. The error correction circuit 140 can be implemented in any receiver device of any of the devices described herein.

In at least one embodiment, the computing system 900 is used for high-speed network communication and includes a processing unit (e.g., CPU 906, GPU 908, GPU 910, CPU 916, GPU 918, GPU 920, NIC/DPU 926, NIC/DPU 928, NIC/DPU 932, NIC/DPU 934, or NIC/DPU 938), and a network interface coupled to the processing unit. The network interface can include the operations and functionality of the DPUs described herein.

In at least one embodiment, the computing system 900 includes a host device and an auxiliary device. The auxiliary device includes a device memory and a processor, communicably coupled to the device memory. The auxiliary device performs the operations described herein with respect to FIG. 1 to FIG. 9. The auxiliary device can include a GPU. The auxiliary device can include a DPU. The auxiliary device can include a DPU. The auxiliary device can include accelerator hardware.

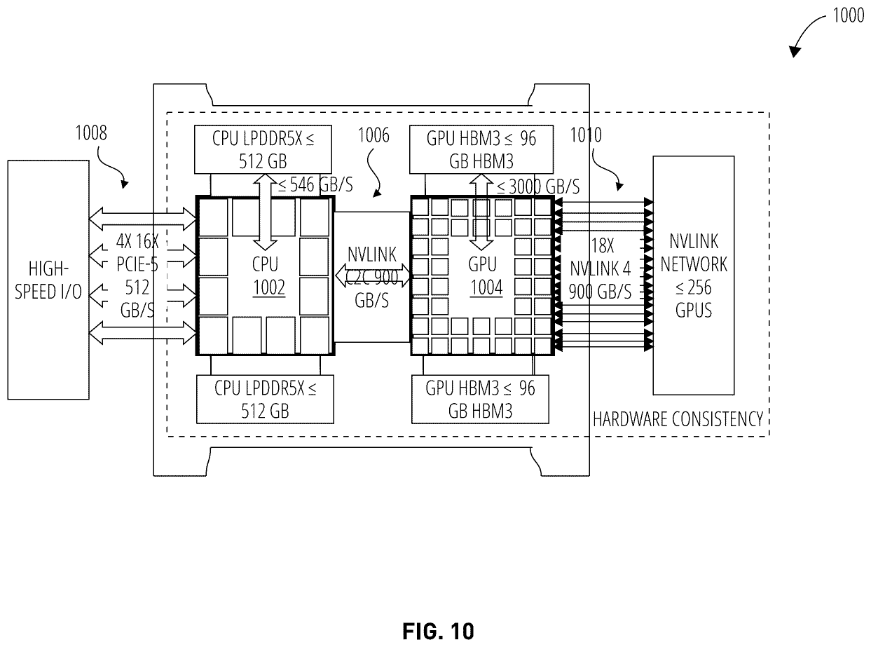

FIG. 10 is a block diagram of a computing system 1000 having a CPU 1002 and a GPU 1004 in a single integrated circuit according to at least one embodiment. The computing system 1000 can be a highly integrated design where a CPU 1002 and GPU 1004 are connected on a single integrated circuit, utilizing an NVLink C2C (Chip-to-Chip) interconnect 1006 to enable fast, low-latency communication between the two processing units. This close integration allows for efficient data transfer and parallel processing between the CPU 1002 and GPU 1004, optimizing performance for complex computational tasks. The GPU elements within the computing system 1000 can be interconnected using an NVLink network, allowing for scalability up to 256 GPU elements, creating a powerful, unified processing environment ideal for large-scale AI, ML, and high-performance computing applications. The NVLink network can be a GPU fabric of high-bandwidth communication interconnects 1010. Additionally, the computing system 1000 can be designed to interface with a high-speed I/O through PCIe interconnects 1008, ensuring rapid data transfer to and from external devices, further enhancing the system's capabilities in handling data-intensive tasks and providing robust connectivity to peripheral components. It should be noted that the C2C interconnects 1006 can be considered D2D interconnects since the CPU 1002 and the GPU 1004 are located on the same integrated circuit. The integrated circuit can include CPU memory (also referred to as main memory) and GPU memory, which are accessible by the CPU 1002 and the GPU 1004, respectively, over high-speed interconnects. The computing system 1000 can bring together performance of the GPU 1004 with the versatility of the CPU 1002. The CPU 1002 can be connected with a high-bandwidth and memory coherent C2C interconnects 1006 in a single integrated circuit. The computing system 1000 can support a link switch system.

The computing system 1000 can include the error correction circuit 140 used for the various embodiments described herein with respect to FIG. 1 to FIG. 9. The error correction circuit 140 can be implemented in any receiver device of any of the devices described herein.

In at least one embodiment, the computing system 1000 is used for high-speed network communication and includes a processing unit, and a network interface coupled to the processing unit. The network interface can include the operations and functionality of the DPUs described herein.

In at least one embodiment, the computing system 1000 includes a host device and an auxiliary device. The auxiliary device includes a device memory and a processor, communicably coupled to the device memory. The auxiliary device performs the operations described herein with respect to FIG. 1 to FIG. 9. The auxiliary device can include a GPU. The auxiliary device can include a DPU. The auxiliary device can include a DPU. The auxiliary device can include accelerator hardware.

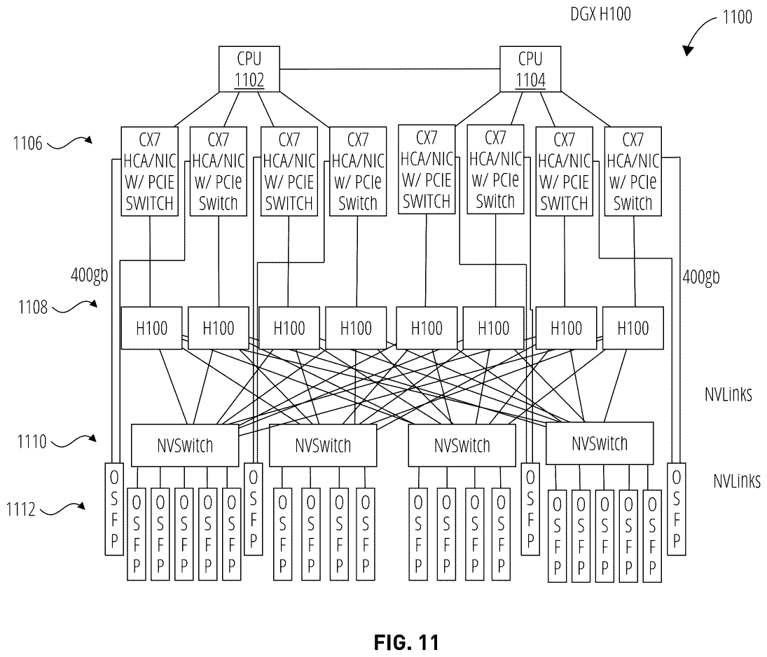

FIG. 11 is a block diagram of a computing system 1100 having tensor core GPUs 1108 according to at least one embodiment. The computing system 1100 can be a DGX H100 system, which is a high-performance computing platform designed to meet the demands of AI, ML, and deep learning (DL) workloads. The computing system 1100 can include multiple tensor core GPUs 1108 (e.g., NVIDIA H100 Tensor Core GPUs). The tensor core GPUs 1108 can each be one of the integrated circuits described above with respect to FIG. 12. The tensor core GPUs 1108 can be optimized for AI/ML/DL applications, offering exceptional performance for deep learning training, inference, and high-performance computing tasks. The tensor core GPUs 1108 within the computing system 1100 are interconnected using high-speed communication interfaces like NVLinks, enabling rapid data transfer between them, which is crucial for handling large-scale AI models and datasets with low latency. This computing system 1100 is designed for scalability, allowing for the integration of additional GPUs as required, making it versatile enough for research, development, and deployment in data centers for production AI workloads. Each GPU is equipped with Tensor Cores, specialized processing units that accelerate matrix operations, a fundamental component of AI and deep learning algorithms. These Tensor Cores enable the system to perform mixed-precision calculations efficiently, balancing speed and accuracy. Given the power consumption and heat generation of multiple tensor core GPUs 1108, the computing system 1100 can include advanced cooling solutions and power management features to ensure safe operation while maintaining peak performance. It is supported by a comprehensive software ecosystem, including NVIDIA's CUDA programming model, AI frameworks like TensorFlow and PyTorch, and other HPC and AI software tools, which enable developers and researchers to harness the full power of the tensor core GPUs 1108 for their specific applications. The computing system 1100 is ideally suited for large-scale AI model training, real-time inference, scientific simulations, data analytics, and other compute-intensive tasks that require massive parallel processing power.

The tensor core GPUs 1108 can be coupled to multiple CPUs, such as CPU 1102 and CPU 1104, using switches 1106 (e.g., CX7 HCA/NIC with PCIe switch). The tensor core GPUs 1108 can be coupled to each other via switches 1110 (e.g., NVSwitches). The switches 1106 and switches 1110 can be coupled to high-speed transceiver modules 1112. The high-speed transceiver modules 1112 can be Octal Small Form-factor Pluggable (OSFP) modules. OSFP modules refer to high-speed transceiver modules designed for rapid data communication, particularly in environments requiring significant bandwidth, such as data centers and high-performance computing systems. These modules support extremely high data rates, typically up to 400 Gbps per module, with future capabilities extending to 800 Gbps or more. OSFP modules interface with the system via the PCIe interface, enabling fast and efficient data transfer between the integrated CPU-GPU components and external networks or other connected systems. Their hot-pluggable nature allows for easy insertion or removal without the need to power down the system, offering flexibility and ease of maintenance, which is crucial in critical-uptime environments. Additionally, OSFP modules are designed for high density, maximizing the number of high-speed connections within limited space, such as in densely packed server racks. By adhering to the latest networking standards, OSFP modules ensure the computing system 1100 remains capable of meeting increasing data demands and can be upgraded to support future advancements in network speeds, thus contributing to the system's overall performance and scalability.

In at least one embodiment, the computing system 1100 can be considered a data-network configuration with full-bandwidth intra-server NVLinks. In this example, all eight tensor core GPUs 1108 can simultaneously saturate eighteen NVLinks to other GPUs within the server. The bandwidth is limited by over-subscription from multiple other GPUs. In another embodiments, data-network configuration can be a half-bandwidth intra-server NVLinks. In this example, all eight tensor core GPUs 1108 can half-subscribe eighteen NVLinks to GPUs in other servers. Four tensor core GPUs 1108 can saturate eighteen NVLinks to GPUs in other servers. This is equivalent of full-bandwidth on AllReduce with Scalable Hierarchical Aggregation and Reduction Protocol (SHARP). The reduction in all-2-all (All2All) bandwidth is a balance with server complexity and costs. In at least one embodiment, all eight tensor core GPUs 1108 can independently transfer data, using Remote Direct Memory Access (RDMA) protocol, over its own dedicated switch (e.g., 400 Gb/s HCA/NIC) in an multi-rail InfiniBand/Ethernet configuration. In this example, 800 GBps of aggregate full-duplex to non-NVLink network devices.

The NICs/switches of computing system 1100 can include the various embodiments described herein with respect to FIG. 1 to FIG. 9.

In at least one embodiment, the computing system 1100 is used for high-speed network communication and includes a processing unit (e.g., CPU 1102, CPU 1104, switches 1106, tensor core GPUs 1108, switches 1110, high-speed transceiver modules 1112), and a network interface coupled to the processing unit. The network interface can include a receiver or a transceiver and perform the corresponding operations and functionalities described herein. The processing unit can include a CPU, a GPU, a DPU, a network adapter, a network switch, an NVLink switch, or the like.

In at least one embodiment, the computing system 1100 includes a host device and an auxiliary device. The auxiliary device includes a device memory and a processor, communicably coupled to the device memory. The auxiliary device performs the operations described herein with respect to FIG. 1 to FIG. 9. The auxiliary device can include a GPU. The auxiliary device can include a DPU. The auxiliary device can include a DPU. The auxiliary device can include accelerator hardware.

Other variations are within the spirit of the present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. The term “connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within range unless otherwise indicated herein, and each separate value is incorporated into the specification as if it were individually recited herein. Use of the term “set” (e.g., “a set of items”) or “subset,” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B, and C,” unless specifically stated otherwise or otherwise clearly contradicted by context, is otherwise understood with the context as used in general to present that an item, term, etc., may be either A or B or C, or any nonempty subset of a set of A and B and C. For instance, in the illustrative example of a set having three members, conjunctive phrases “at least one of A, B, and C” and “at least one of A, B, and C” refers to any of the following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, the term “plurality” indicates a state of being plural (e.g., “a plurality of items” indicates multiple items). A plurality is at least two items but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. A set of non-transitory computer-readable storage media, in at least one embodiment, comprises multiple non-transitory computer-readable storage media, and one or more individual non-transitory storage media of multiple non-transitory computer-readable storage media lack all of the code while multiple non-transitory computer-readable storage media collectively store all of the code. In at least one embodiment, executable instructions are executed such that different instructions are executed by different processors-for example, a non-transitory computer-readable storage medium stores instructions, and a main CPU executes some of the instructions while a GPU executes other instructions. In at least one embodiment, different components of a computer system have separate processors, and different processors execute different subsets of instructions.

Accordingly, in at least one embodiment, computer systems are configured to implement one or more services that singly or collectively perform operations of processes described herein, and such computer systems are configured with applicable hardware and/or software that enable the performance of operations. Further, a computer system that implements at least one embodiment of present disclosure is a single device and, in another embodiment, is a distributed computer system comprising multiple devices that operate differently such that the distributed computer system performs operations described herein and such that a single device does not perform all operations.

Use of any and all examples, or exemplary language (e.g., “such as”) provided herein, is intended merely to better illuminate embodiments of the disclosure, and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

The terms “coupled” and “connected,” along with their derivatives, may be used in the description and claims. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other but yet still CO-operate or interact with each other.

Unless specifically stated otherwise, it may be appreciated that throughout specification terms such as “processing,” “computing,” “calculating,” “determining,” or like, refer to action and/or processes of a computer or computing system or similar electronic computing devices, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, a “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes for carrying out instructions in sequence or parallel, continuously, or intermittently. The terms “system” and “method” are used herein interchangeably as far as a system may embody one or more methods, and methods may be considered a system.

In the present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways, such as by receiving data as a parameter of a function call or a call to an application programming interface. In some implementations, the process of obtaining, acquiring, receiving, or inputting analog or digital data can be accomplished by transferring data via a serial or parallel interface. In another implementation, the process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, the process of providing, outputting, transmitting, sending, or presenting analog or digital data can be accomplished by transferring data as an input or output parameter of a function call, a parameter of an application programming interface, or inter-process communication mechanism.

Although the discussion above sets forth example implementations of described techniques, other architectures may be used to implement the described functionality and are intended to be within the scope of this disclosure. Furthermore, although specific distributions of responsibilities are defined above for purposes of discussion, various functions and responsibilities might be distributed and divided in different ways, depending on circumstances.

Furthermore, although the subject matter has been described in language specific to structural features and/or methodological acts, it is to be understood that the subject matter claimed in appended claims is not necessarily limited to specific features or acts described. Rather, specific features and acts are disclosed as exemplary forms of implementing the claims.

What is claimed is:

1. An interconnect circuit comprising:
a physical (PHY) layer comprising a transmitter; and
a data link layer coupled to the PHY layer, the data link layer comprising credit-check logic coupled between first-level arbitration logic and second-level arbitration logic, the credit-check logic to:
receive, from the first-level arbitration logic for each of a plurality of traffic types, a selected request to send a packet over a link; and
block one or more of the selected requests from being passed from the first-level arbitration logic to the second-level arbitration logic responsive to determining i) a lack of available shared credits in a shared credit pool, or ii) a lack of available dedicated credits assigned to the respective traffic type.

2. The interconnect circuit of claim 1, wherein the data link layer further comprises:
the first-level arbitration logic, the first-level arbitration logic to receive, from a plurality of clients, a plurality of requests to send packets over the link, and provide the selected request for each of the plurality of traffic types to the credit-check logic; and
the second-level arbitration logic, the second-level arbitration logic is to select one of the selected requests received from the credit-check logic, and provide the one of the selected requests to the transmitter to send the respective packet over the link.

3. The interconnect circuit of claim 2, wherein the credit check logic is further to block one or more of the selected requests from being passed from the first-level arbitration logic to the second-level arbitration logic responsive to determining i) the lack of available shared credits in the shared credit pool above a specified minimum amount of shared credits, or ii) the lack of available dedicated credits assigned to the respective traffic type, and wherein the second-level arbitration logic implements a Weighted Least Recently Used (WLRU) arbitration scheme.

4. The interconnect circuit of claim 1, wherein the credit-check logic is to:
determine i) the lack of available shared credits in the shared credit pool by determining that a first value, representing an amount of available shared credits in the shared credit pool, is not greater than a specified minimum amount of shared credits; and
determine ii) the lack of available dedicated credits assigned to the respective traffic type by determining that a second value, representing a request length of the respective selected request, is greater than a third value, representing an amount of available dedicated credits assigned to the respective traffic type.

5. The interconnect circuit of claim 1, wherein the credit-check logic comprises:
a first credit gate assigned to a first traffic type of the plurality of traffic types, wherein the first credit gate, is to determine, for a first selected request received from the first-level arbitration logic, whether a first value, representing an amount of available shared credits in the shared credit pool, is greater than a specified minimum amount of shared credits or whether a second value, representing a request length of the first selected request, is less than or equal to a third value, representing an amount of available dedicated credits assigned to the first traffic type, wherein the first credit gate is to pass the first selected request to the second-level arbitration logic responsive to the first value being greater than the specified minimum amount or the second value being less than or equal to the third value; and
a second credit gate assigned to a second traffic type of the plurality of traffic types, wherein the second credit gate, is to determine, for a second selected request received from the first-level arbitration logic, whether the first value is greater than the specified minimum amount or whether a fourth value, representing a request length of the second selected request, is less than or equal to a fifth value, representing an amount of available dedicated credits assigned to the second traffic type, wherein the second credit gate is to pass the second selected request to the second-level arbitration logic responsive to the first value being greater than the specified minimum amount or the fourth value being less than or equal to the fifth value.

6. The interconnect circuit of claim 1, wherein the data link layer further comprises credit replenishment logic to:
specify a first fixed credit share for a first client group corresponding to a first traffic type;
specify a second fixed credit share for a second client group corresponding to a second traffic type; and
on a credit release of a set of credits from a link partner, equally distribute the set of credits across the first client group and the second client group, wherein, responsive to the first client group reaching the first fixed credit share, the credit replenishment logic stops adding credits from the set of credits to the first client group, and wherein, responsive to the second client group reaching the second fixed credit share, the credit replenishment logic stops adding credits from the set of credits to the second client group.

7. The interconnect circuit of claim 6, wherein the first client group corresponds to isochronous (iso) clients, wherein the second client group corresponds to non-isochronous (non-iso) clients.

8. The interconnect circuit of claim 1, wherein the credit check logic is further to block one or more of the selected requests from being passed from the first-level arbitration logic to the second-level arbitration logic responsive to determining i) the lack of available shared credits in the shared credit pool above a specified minimum amount of shared credits, or ii) the lack of available dedicated credits assigned to the respective traffic type, and wherein the specified minimum amount of shared credits is based on i) a maximum packet size supported by the interconnect circuit, or ii) a maximum packet size of packets waiting for arbitration in a current cycle.

9. A transmitter device comprising:
a transmitter; and
a controller coupled to the transmitter, wherein the controller comprises:
first-level arbitration logic to receive, from a plurality of clients, a plurality of requests to send packets, and provide a selected request for each of a plurality of traffic types;
second-level arbitration logic to select one of the selected requests from the first-level arbitration logic, and provide the one of the selected requests to the transmitter to send the respective packet; and
credit-check logic coupled between the first-level arbitration logic and the second-level arbitration logic, the credit-check logic to receive the selected requests from the first-level arbitration logic, and, for each of the selected requests, either i) pass the respective selected request to the second-level arbitration logic if a first value representing available shared credits in a shared credit pool is greater than a minimum value or a request length of the respective selected request is less than a second value representing available dedicated credits in a dedicated credit pool assigned to the respective traffic type, or ii) otherwise block the respective selected request from being passed to the second-level arbitration logic.

10. The transmitter device of claim 9, wherein the controller further comprises credit replenishment logic to:
specify a first fixed credit share for a first client group corresponding to a first traffic type;
specify a second fixed credit share for a second client group corresponding to a second traffic type; and
on a credit release of a set of credits from a link partner, equally distribute the set of credits across the first client group and the second client group, wherein, responsive to the first client group reaching the first fixed credit share, the credit replenishment logic stops adding credits from the set of credits to the first client group, and wherein, responsive to the second client group reaching the second fixed credit share, the credit replenishment logic stops adding credits from the set of credits to the second client group.

11. The transmitter device of claim 10, wherein the first client group corresponds to isochronous (iso) clients, wherein the second client group corresponds to non-isochronous (non-iso) clients.

12. The transmitter device of claim 9, wherein the credit-check logic comprises:
a first credit gate assigned to a first traffic type of the plurality of traffic types, wherein the first credit gate, is to determine, for a first selected request received from the first-level arbitration logic, whether the first value is greater than the minimum value or whether the request length of the first selected request is less than or equal to the second value, representing an amount of available dedicated credits assigned to the first traffic type, wherein the first credit gate is to pass the first selected request to the second-level arbitration logic responsive to the first value being greater than the minimum value or the request length of the first selected request being less than or equal to the second value; and
a second credit gate assigned to a second traffic type of the plurality of traffic types, wherein the second credit gate, is to determine, for a second selected request received from the first-level arbitration logic, whether the first value is greater than the minimum value or whether the request length of the second selected request is less than or equal to the second value, representing an amount of available dedicated credits assigned to the second traffic type, wherein the second credit gate is to pass the second selected request to the second-level arbitration logic responsive to the first value being greater than the minimum value or the request length of the second selected request being less than or equal to the second value.

13. The transmitter device of claim 9, wherein the second-level arbitration logic implements a Weighted Least Recently Used (WLRU) arbitration scheme.

14. A method of operating data link layer of an interconnect circuit, the method comprising:
receiving, from first-level arbitration logic for each of a plurality of traffic types, a selected request to send a packet over a link; and
blocking one or more of the selected requests from being passed from the first-level arbitration logic to second-level arbitration logic responsive to determining i) a lack of available shared credits in a shared credit pool, or ii) a lack of available dedicated credits assigned to the respective traffic type.

15. The method of claim 14, further comprising passing one or more of the selected requests received from the first-level arbitration logic to the second-level arbitration logic responsive to determining iii) an availability of shared credits in the shared credit pool above a specified minimum amount of shared credits, or iv) an availability of dedicated credits assigned to the respective traffic type.

16. The method of claim 14, further comprising:
receiving, at the first-level arbitration logic from a plurality of clients, a plurality of requests to send packets over the link;
selecting, at the second-level arbitration logic, a request from the one or more selected requests passed from the first-level arbitration logic; and
sending the packet, corresponding to the request, over the link.

17. The method of claim 16, wherein selecting the request comprises selecting the request from the one or more selected requests using a Weighted Least Recently Used (WLRU) arbitration scheme.

18. The method of claim 14, wherein:
determining i) the lack of available dedicated credits assigned to the respective traffic type comprises determining that a first value, representing an amount of available shared credits in the shared credit pool, is not greater than a specified minimum amount of shared credits; and
determining ii) the lack of available dedicated credits assigned to the respective traffic type comprises determining that a second value, representing a request length of the respective selected request, is greater than a third value, representing an amount of available dedicated credits assigned to the respective traffic type.

19. The method of claim 14, further comprising:
determining, using a first credit gate assigned to a first traffic type of the plurality of traffic types for a first selected request received from the first-level arbitration logic, whether a first value, representing an amount of available shared credits in the shared credit pool, is greater than a specified minimum amount of shared credits or whether a second value, representing a request length of the first selected request, is less than or equal to a third value, representing an amount of available dedicated credits assigned to the first traffic type;
passing, using the first credit gate, the first selected request to the second-level arbitration logic responsive to the first value being greater than the specified minimum amount or the second value being less than or equal to the third value;
determining, using a second credit gate assigned to a second traffic type of the plurality of traffic types, for a second selected request received from the first-level arbitration logic, whether the first value is greater than the specified minimum amount or whether a fourth value, representing a request length of the second selected request, is less than or equal to a fifth value, representing an amount of available dedicated credits assigned to the second traffic type; and
passing, using second credit gate, the second selected request to the second-level arbitration logic responsive to the first value being greater than the specified minimum amount or the fourth value being less than or equal to the fifth value.

20. The method of claim 14, further comprising:
specifying a first fixed credit share for a first client group corresponding to a first traffic type;
specifying a second fixed credit share for a second client group corresponding to a second traffic type;
on a credit release of a set of credits from a link partner, equally distributing the set of credits across the first client group and the second client group;
responsive to the first client group reaching the first fixed credit share, stopping an addition of credits from the set of credits to the first client group; and
responsive to the second client group reaching the second fixed credit share, stopping an addition of credits from the set of credits to the second client group.

21. The method of claim 14, wherein the second-level arbitration logic implements a Weighted Least Recently Used (WLRU) arbitration scheme.

22. A system for high-speed network communication, the system comprising:
a processing unit; and
a network interface coupled to the processing unit, wherein the network interface comprises a transmitter device comprising:
a physical (PHY) layer comprising a transmitter; and
a data link layer coupled to the PHY layer, the data link layer comprising credit-check logic coupled between first-level arbitration logic and second-level arbitration logic, the credit-check logic to:
receive, from the first-level arbitration logic for each of a plurality of traffic types, a selected request to send a packet over a link; and
block one or more of the selected requests from being passed from the first-level arbitration logic to the second-level arbitration logic responsive to determining i) a lack of available shared credits in a shared credit pool, or ii) a lack of available dedicated credits assigned to the respective traffic type.

23. The system of claim 22, wherein the processing unit comprises at least one of a central processing unit (CPU), a graphics processing unit (GPU), a data processing unit (DPU), a network adapter, a network switch, or an NVLink switch.
